(19) United States
(12) Patent Application Publication
(10) Pub. No.: US 2019/0033073 A1
(43) Pub. Date: Jan. 31, 2019

(54) Low cost ocean surface drifter for satellite tracking

(71) Applicant: Charles Mazof, Needham, MA (US)

(72) Inventor: Charles Mazof, Needham, MA (US)

(21) Appl. No.: 16/100,109

(22) Filed: Aug. 9, 2018

(51) Int. Cl. G01C 13/00; B63B 22/00

(52) U.S. Cl. CPC G01C 13/002; B63B 2022/006; B63B 2213/02; B63B 22/003

(57) ABSTRACT

An ocean floating drifter, which can be very quickly assembled at low cost in urgent situation, can accurately trace ocean surface currents with help of global positioning device to transmit periodically data and position information to satellites. The drifter includes a cylinder shape made of materials which can protect the electronic GPS tracker device in it. A conical shape at lower end is used to lower the impact during air drop. The weight amount at the bottom can be pre-adjusted to simulate different the wind effect during the drifting. The drifter can be kept relatively stable position during its drifting to let its GPS device reliably communicate with satellites. The drifter has special provisions to sustain impact during air drop, resist corrosion, fish-bite damage and biological fouling.

### FIELD OF TECHNOLOGY

The present invention relates to a drifting device which measures an ocean current moving speed and direction. It would be widely used in maritime search and rescue operations and tracking wreckage. Drifters are equipped with global positioning system devices which send live drifter locations at regular intervals.

### BACKGROUND OF THE INVENTION

The accurate tracking of ocean currents can be obtained by deploying a large number of ocean drifters in a particular area. The tracking process and lifetimes can range from days to several years. In a sudden event such as the search for a missing aircraft at sea, it is critical to have a large number of drifters available and deployed as quickly as possible, ideally within hours and no more than a few days. Additionally, in order for the drifter to have practical use, there are several other common considerations and requirements met.

It is desirable to design a drifter with building materials easily obtainable without the need for customized manufacturing, so that when time is of the essence, these drifters can be locally assembled. It is also preferable that the drifters can be assembled easily, quickly and by hand. When all materials are available, ideally each drifter can be assembled within a few minutes.

For standard use a drifter is equipped with a GPS device which can send its location via satellite. Most GPS devices on the market are not water-resistant and needs to face upwards for a stronger connection to the satellites. The drifter should protect the GPS device from water at all times, but simultaneously not interfere with the connection between the GPS and the satellite. Ideally, the drifter should never flip over and will ensure that the GPS face upwards at all times.

The drifting path of each drifter device can be affected by natural events such as wind. When this occurs, it is also desirable that the submerged level of the drifter can be pre-adjusted in order to account for the potential variance of wind strength.

Depending on different needs, a drifter may need to float in ocean for months or even years. Therefore, the body of the drifter needs to be strong enough to resist harsh ocean environments including erosion from waves and salt water, potentially cold temperatures, interference from aquatic life and collision with obstacles. Also preferable is for the drifter to be strong enough to allow for aerial deployment.

Currently, it is difficult to find a drifter that has met all of the above requirements.

### SUMMARY OF THE INVENTION

Aspects of the embodiment of the present disclosure are directed towards the apparatuses and methods of having a drifter able to measure ocean current speeds and directions with the consideration of wind effects. The design of the drifter includes a configurable level of submersion to account for varying degrees of wind effects.

According to an embodiment of the present disclosure, a cylindrical shell constructed with polyvinyl chloride or PVC, with two end caps sealing the device, is used as the main body of the drifter.

In one embodiment, the internal minimum diameter of the drifter should be large enough to hold a GPS device which needs to be fixed in direction. Typical diameter size can be between 2 inches to 12 inches.

In one embodiment, the length of the drifter is 3-6 times its diameter size. There are materials such as sand, concrete or small rocks filling an interior chamber to use as a counterweight for the buoyancy. This weight would be located at the bottom of the drifter when floating and can keep one end facing down all the times in the water no matter the initial position, so that the GPS on the other end is kept facing up at all times.

In one embodiment, the weight material filling in the bottom can be adjusted, so that submersion level of the drifter below the water line can be pre-adjusted.

In one embodiment, above the heavy weight materials filling in the bottom, there is a light solid foam filling in between the weight material and the GPS. The diameter of this foam is near or the same as the internal diameter of the PVC tube, so that the internal space of the drifter can be filled snugly. The GPS sits above the foam and underneath the top cap with minimal gap remaining in between.

In one embodiment, the GPS inside the drifter is configured to be able to signal its position to satellites at predetermined intervals.

In one embodiment, the body and the two caps can be sealed using PVC solvent cement.

Further scope of the applicability of the described systems and apparatuses will become apparent from the following detailed descriptions, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Furthermore, various components of the same type may be distinguished by following the reference label with a dash and a second label distinguishing between similar components. If only the first reference label is used in the specification, the description is applicable to any one of the similar components having the same first reference label irrespective of the second reference label. Some of the embodiments will be described in detail, with reference to the following figures, wherein like designations denote like members, wherein:

FIG. 1 is a simplified block diagram illustrating a perspective 3-D view of a drifter;

FIG. 2 is a simplified block diagram illustrating a side view of the drifter;

FIG. 3 is a simplified block diagram illustrating a top view of the drifter including a global positioning device without the top cap;

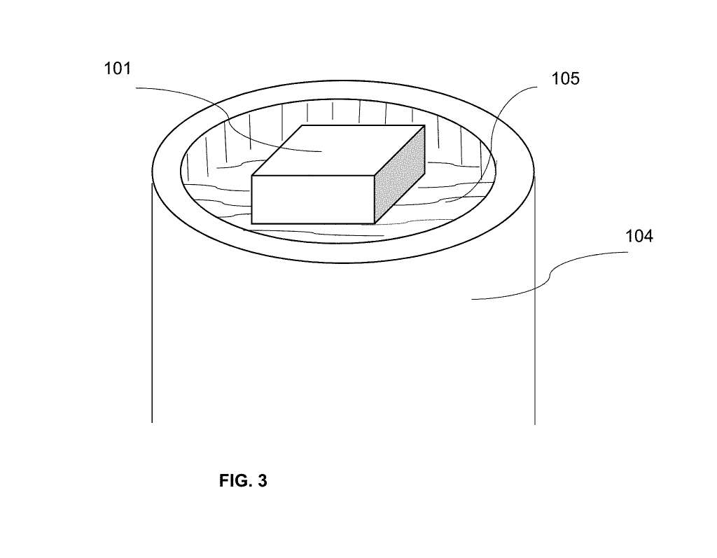

FIG. 4 is a simplified block diagram illustrating a perspective 3-D view of a cap of the drifter, which can be either the top cap or bottom cap.

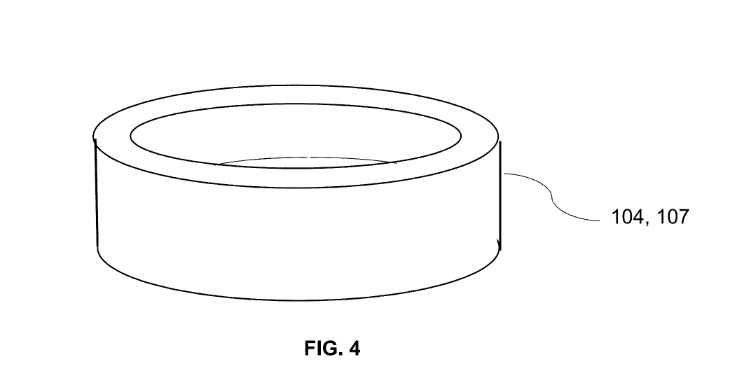

### DETAILED DESCRIPTION OF THE PREFFERRED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

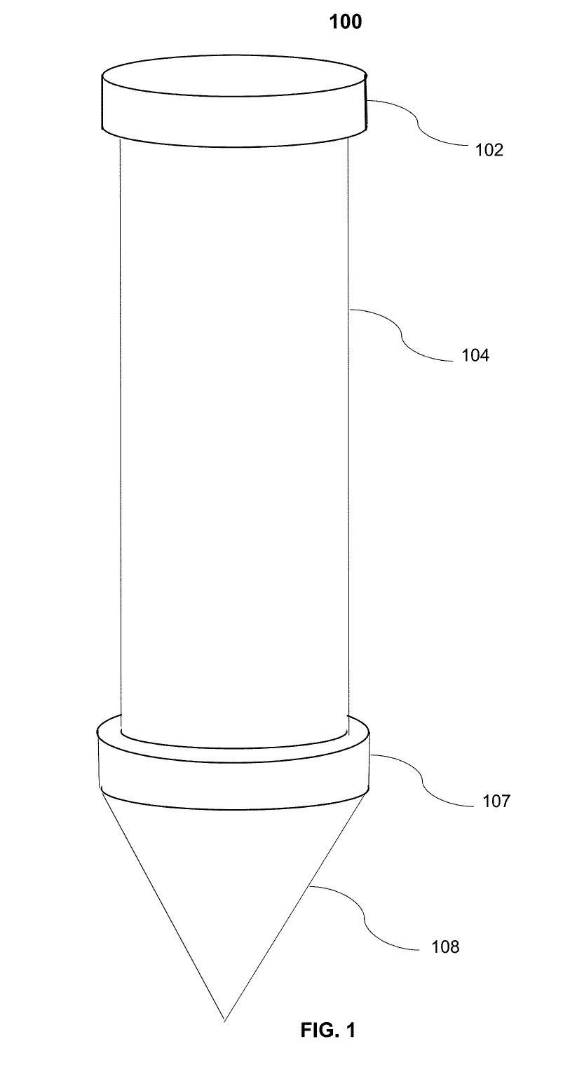

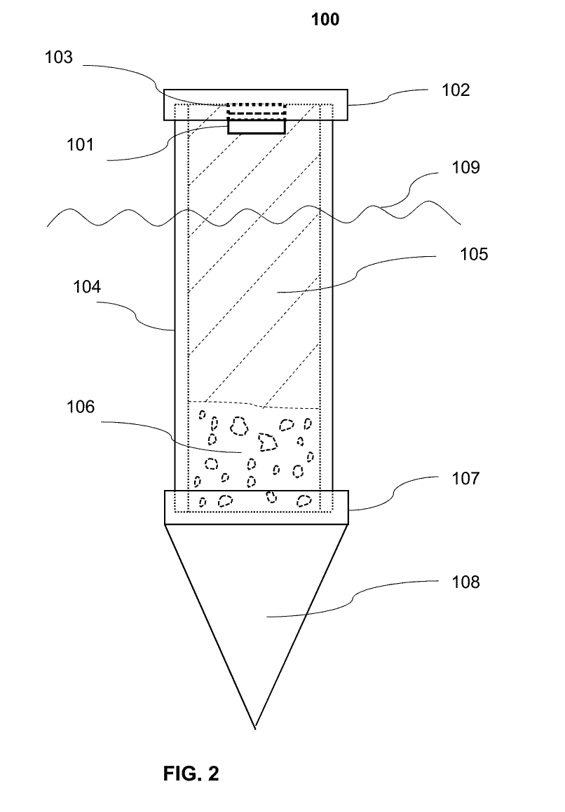

Refer to FIG. 1 and FIG. 2, an ocean drifter 100 according to a preferred embodiment of the invention is provided. The shape of a drifter in FIG. 100 is generally a cylinder shape body 104 with two caps 102 and 107 at the top and at the bottom respectively. Attached to the bottom is a conical 108 made with the same solid material as the cylinder. The outside diameter of the cylinder is either 3.5 inches (88.900 mm) or 4.5 inches (114.300 mm) while the height is the cylinder is between 12-24 inches which doesn't include the conical part at the bottom. The height of the conical is at least the same as its diameter or greater. The caps 102 and 107 have the exact the same inner diameter as the outside diameter of the cylinder 104, so the caps can tightly fit and cover the cylinder.

The materials used for the cylinder 104, the caps 102 and 107, the conical are all schedule 40 PVC (Polyvinyl Chloride). Typically, the wall thickness of the cylinder or the pipe is 0.216 inches and 0.237 inches respectively for 3.5 inches and 4.5 inches cylinder respectively. The conical is also made of the same PVC material. This conical is optional when the drifter is deployed in low attitudes such as from the boat, but it is necessary if dropped from the air.

The cap and the cylinder are sealed using PVC solvent cement. The conical and the bottom cap can be attached together using general water-resistant glue.

The bottom cap will be first sealed using PVC solvent cement. The bottom conical shape is attached at the bottom when the drifter to be dropped from high altitude. This conical shape can help to decrease the impact force to prevent damaging the GPS device when the drifter is entering the water from high altitude. Otherwise the conical part is not necessary.

Inside the cylindrical PVC shell, heavy weight materials 106 such as small crushed stones or sand are put in the bottom of the drifter after the bottom cap is sealed and cured. For the first drifter to be built, it is needed to test the volume of the weight to be added. The amount of weight to be added is depending on how much of the drifter needs to be floating above the water. The more space the drifter needs to be above the water, the less weight needs to be added.

Above the weight materials 106, a light foam 105 is inserted inside the cylinder. The materials can be like polyethylene or polyurethane. The foam should occupy the whole space with minimal space remaining, in other words, the diameter of the form is the same or near the inside diameter of the cylinder.

The volume of the weighing material 106 can be adjusted depending on how much body of the drifter needs to be floating above the water line 109.

At the top of the foam 105, cutting a space on the foam to fit GPS 101. The GPS is put inside the cutting space above the foam 106. The GPS may need to face up according to the GPS specification or its operation requirement. A thin slice of foam 103 with its thickness of 5-20 mm is put above the GPS.

After the weight materials, the form, the GPS and the thin foam above the GPS are all in their positions, the top cap 102 is cemented and sealed to the cylinder.

The assembled drifter can be dropped to the water for use almost immediately after a 15-20 minutes cure time.

1. An ocean drifter used to follow ocean surface currents comprising:
a hollow cylinder shape body with sealed caps on both the top and bottom ends;
a conical shape made with the same materials as the cylinder is attached to the bottom;
weighing materials, foam, GPS and foam slice are subsequently inserted into the cylinder from the bottom to the top;
a global positioning tracker device is sitting above the foam at near the top inside of cylinder and can transmit its location to satellites periodically;

2. The drifter assembly according to claim 1 where the hollow cylinder, caps at the two ends and conical shape at the bottom are all made of PVC;

3. The drifter assembly according to claim 1 where the conical shape attached to the bottom is optional for non air drop uses, it is required in the case of air drop.

4. The drifter assembly according to claim 3 where the conical shape at the bottom is also acting as weighing material. It is made of solid but the same materials as its cylinder body in claim 1.

5. The drifter assembly according to claim 1 where the caps and conical are attached to the cylinder using PVC solvent cement, which is mainly tetrahydrofuran;

6. The drifter assembly according to claim 1 where the weighing materials is crushed stones and/or sand;

7. The drifter assembly according to claim 6 where the weight materials is adjusted to control how much body floating above water to take wind effect.

8. The drifter assembly according to claim 1 where the foam materials is polyethylene or polyurethane;

9. The drifter assembly according to claim 8 where the foam is used to support and hold electronic satellite tracker device at the top of the drifter;

10. The drifter assembly according to claim 1 where a range from 5 mm to 20 mm thick foam is placed between the GPS or electronic device and the cap.

11. There is no space remaining among these items inside the cylinder body, including weighing materials, foam, GPS and caps in claims 8, 9 and 10.
